(19) United States
(12) Patent Application Publication
(10) Pub. No.: US 2008/0299337 A1
(43) Pub. Date: Dec. 4, 2008

(54) Method for the formation of surfaces on the inside of medical devices

(75) Inventors: David A. Glocker, West Henrietta, NY (US); Brent C. Bell, Fairport, NY (US)

Correspondence Address: SIMPSON & SIMPSON, PLLC, 5555 MAIN STREET, WILLIAMSVILLE, NY, 14221-5406, US

(73) Assignee: Isoflux, Inc., Rochester, NY (US)

(21) Appl. No.: 12/221,612

(22) Filed: Aug. 5, 2008

Related U.S. Application Data
(63) Continuation-in-part of application No. 11/704,650, filed on Feb. 9, 2007.
(60) Provisional application No. 60/771,834, filed on Feb. 9, 2006.

(51) Int. Cl. B32B 3/26; B05D 5/00; H05H 1/00

(52) U.S. Cl. 428/34.1; 427/569; 427/300; 428/195.1; 428/304.4; 428/336

(57) ABSTRACT

A method of manufacturing a medical device having interior and exterior surfaces, the method including the steps of: a) shielding the exterior surface; and, b) exposing the interior surface to a plasma, wherein the shielding of the exterior surface substantially prevents exposure of the exterior surface to the plasma.

### CROSS-REFERENCE TO RELATED APPLICATIONS

This application is a Continuation-in-Part of application Ser. No. 11/704,650, filed on Feb. 9, 2007, which application claims the benefit of Provisional Application Ser. No. 60/771,834, filed Feb. 9, 2006, which applications are each incorporated herein by reference.

### FIELD OF THE INVENTION

This invention broadly relates to means for modifying surfaces by deposition and etching, and more specifically, to means for creating structures and materials selectively on the inside surfaces of medical devices to render the devices biocompatible, to provide drug elution capability and/or to promote cell growth on and cell attachment to the modified surface.

### BACKGROUND OF THE INVENTION

Many medical devices, such as stents and stent grafts, are designed and manufactured to be inserted into the wall or lumen of a blood vessel. When this is done, complications may arise from the body's natural reaction to a foreign object. For example, inserting a stent into a blood vessel may cause the growth of an undesirable thick layer of smooth muscle tissue, and this new growth may cause restenosis, or re-narrowing of the vessel. The effects of restenosis are often minimized through the use of drug eluting stents, in which a medicated coating on the stent prevents tissue growth for a period of time. Thrombus formation is another serious condition that may occur after insertion of a stent, and recent studies have shown that current drug eluting stents can not prevent, and may even promote, thrombosis formation. See, for example, Windecker, S. et al. Randomized Comparison of a Titanium-Nitride-Oxide-Coated Stent With a Stainless Steel Stent for Coronary Revascularization, Circulation, 111:2617-2622 (2005).

The inner surface of a healthy blood vessel is lined with endothelial cells, which play an important role in controlling thrombosis, inflammation and other factors. It has generally been found that endothelial cells do not readily attach to the smooth inner surfaces of electropolished metal stents or to the polymers typically used for drug eluting stents. U.S. Pat. No. 6,140,127 discusses the desirability of having endothelial cells attach to the inner walls of stents, and overcomes the previously described attachment issue by using an adhesion specific peptide. Similarly, U.S. Pat. No. 6,478,815 discusses means for overcoming the attachment issue, however in this instance a stent is made primarily of niobium which can be coated with iridium oxide or other materials to promote the growth of endothelial cells. Additionally, a roughened surface on a stent has been proposed as a further means for promoting cell growth on a stent. For example, U.S. Pat. No. 6,820,676 B2 and United States Patent Application Publication No. 2005/0232968 discuss the role of surface inhomogeneities and surface structures in promoting endothelial cell growth.

While the growth of endothelial cells on the inner surface of a stent is highly desirable, the growth of smooth muscle tissue at the inner wall of the blood vessel, i.e., the portion in contact with the outer surface of the stent, is undesirable. It has been found that stents coated entirely with a drug imbibed polymer layer designed to prevent growth of smooth muscle tissue have been highly successful in reducing in-stent restenosis. Unfortunately, the smooth polymer surface also inhibits endothelial cell growth on the inside of the stent. For example, the use of a drug eluting coating on the outer surface of stents is taught in United States Patent Application Publication No. 2006/0200231, however tailoring the properties of the inner surface for endothelial cell growth is not addressed. Stents having outer and inner surfaces which function differently would overcome the defects described supra.

Many references that discuss surfaces to control cell growth, i.e., to enhance cell growth in the case of endothelial cells or suppress cell growth in the case of smooth muscle cells, are based on plasma processing and physical vapor deposition. As stents have a generally open structure, when they are coated or treated in a plasma environment both inner and outer surfaces typically receive the same or very similar coatings or treatments. United States Patent Application Publication No. 2006/0200231 describes a well-know means of coating only the outside surface of an object like a stent. The stent is placed on a mandrel which prevents the inner surfaces from receiving a coating while the outer surface is coated. Heretofore, nothing in the prior art suggests a means for plasma treating or coating only the inner surface of a medical device such as a stent, while leaving the outer surface largely unaltered, or allowing the outer surface to receive a different coating or treatment.

As can be derived from the variety of devices and methods directed at coating and treating implantable medical devices, many means have been contemplated to accomplish the desired end, i.e., surface specific coatings wherein a first surface promotes cell growth thereon and a second surfaces prevents cell growth thereon. Heretofore, tradeoffs between preventing cell growth on one surface and promoting cell growth on another surface were required. Thus, there is a long-felt need for a method to treat or coat only the inner surfaces of medical devices such as shunts, stent-grafts and stents, as a means of preparing the inner and outer surfaces of such devices so that they function differently.

### BRIEF SUMMARY OF THE INVENTION

The present invention broadly comprises a method of modifying a surface to produce surface structures, coatings and inhomogeneities in order to promote cell growth on and/or attachment to the surface for a variety of applications. Generally, the subject invention includes plasma deposition and removal processes to produce nanometer scale surface structures and coatings primarily on the inner surfaces of devices having both inner and outer wall surfaces, e.g., stents, stent-grafts and shunts. Specifically, the invention includes methods for producing plasma glow discharges on the inside of medical devices.

The present invention also broadly comprises a method of manufacturing a medical device having interior and exterior surfaces, the method includes the steps of: a) shielding the exterior surface; and, b) exposing the interior surface to a plasma, wherein the shielding of the exterior surface substantially prevents exposure of the exterior surface to the plasma. In some embodiments, the medical device further includes a first cross-sectional shape; while the step of shielding the exterior surface further includes the step of: contacting the exterior surface of the medical device with an inner surface of a hollow electrically conducting tube, the inner surface having a second cross-sectional shape substantially similar to the first cross-sectional shape; and, the step of exposing the interior surface to the plasma further includes the step of: igniting a hollow cathode discharge within the hollow electrically conducting tube. In other embodiments, the step of exposing the interior surface to the plasma further includes the step of: simultaneously sputtering the tube and the medical device. In some of these embodiments, the step of simultaneously sputtering the tube and the medical device modifies the interior surface of the medical device to include an inhomogeneous surface having at least two materials, while in some of these embodiments, the inhomogeneous surface includes a plurality of individual regions and each of the individual regions includes at least two materials and is separated from others of the individual regions by a material boundary. In still yet other embodiments, the step of exposing the interior surface to the plasma further includes the step of: cooling the hollow electrically conducting tube.

In further embodiments of the present invention, the medical device further includes a first cross-sectional shape; while the step of shielding the exterior surface further includes the step of: contacting the exterior surface of the medical device with an inner surface of a hollow electrically insulating tube, the inner surface having a second cross-sectional shape substantially similar to the first cross-sectional shape; and, the step of exposing the interior surface to the plasma further includes the step of: igniting a discharge within the hollow electrically insulating tube using a radio frequency power. In some of these embodiments, the radio frequency power includes a capacitively coupled radio frequency field, while in others of these embodiments, the radio frequency power includes an inductively coupled radio frequency field. In some embodiments, the step of exposing the interior surface to the plasma further includes the step of: cooling the hollow electrically insulating tube.

In yet further embodiments of the present invention, the medical device further includes a first cross-sectional shape; while the step of shielding the exterior surface further includes the step of: contacting the exterior surface of the medical device with an inner surface of a hollow electrically insulating tube, the inner surface having a second cross-sectional shape substantially similar to the first cross-sectional shape; and, the step of exposing the interior surface to the plasma further includes the step of: igniting a discharge within the hollow electrically insulating tube using a microwave power. In some embodiments, the step of exposing the interior surface to the plasma further includes the step of: cooling the hollow electrically insulating tube.

In still yet further embodiments, the step of exposing the interior surface to the plasma is performed in an inert gas, while in other embodiments, the step of exposing the interior surface to the plasma is performed in a reactive gas selected from the group consisting of: oxygen, nitrogen, methane and mixtures thereof. In still other embodiments, the step of exposing the interior surface to the plasma is performed in a precursor gas, and the precursor gas is selected to deposit a coating on the interior surface, and in some of these embodiments, the precursor gas is selected from the group consisting of: a hydrocarbon, a metal containing compound, oxygen, nitrogen and mixtures thereof. In some embodiments, the coating includes a plurality of clusters and each of the clusters includes a lateral dimension from about ten nanometers to about one thousand nanometers. In other embodiments, each of the clusters have a size and a distance from others of the clusters, and in some of these embodiments, the size of each of the clusters and the distance from others of the clusters are chosen to preferentially bind at least one biological structure having a specific size.

In yet further embodiments, the step of exposing the interior surface to the plasma removes material from the interior surface of the medical device, while in other embodiments, the present invention method further includes the step of: c) coating at least the interior surface of the medical device with a biodegradable polymer after the step of exposing the interior surface to the plasma. In some embodiments, a medical device is constructed according to the present invention method.

The present invention further broadly comprises a medical device having an interior surface, an exterior surface and means for exposing the interior surface to at least one plasma. In some embodiments, the at least one plasma includes a first plasma and a second plasma, the first plasma deposits a plurality of clusters on the interior surface and the second plasma etches the interior surface. In other embodiments, the first and second plasmas produce a plurality of surface structures on the medical device. In some of these embodiments, each of the surface structures includes a lateral dimension from about ten nanometers to about one thousand nanometers, while in others of these embodiments, each of the surface structures includes a height from about one hundred nanometers to about ten thousand nanometers. In some embodiments, each of said clusters includes a size and a distance from others of the clusters, and in other embodiments, the size of each of the clusters and the distance from others of the clusters are chosen to preferentially bind at least one biological structure having a specific size.

It is a general object of the present invention to provide a medical device including an interior surface having different characteristics than the device's exterior surface.

It is another general object of the present invention to provide a medical device having an interior surface which includes surface structures, coatings and/or inhomogeneities.

It is yet another object of the present invention to provide a method of producing a plasma glow discharge on the inside of a medical device while substantially shielding the outside of the device from such discharge.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a cross sectional view of a portion of a typical stent taken generally along a plane parallel to the longitudinal axis of the stent;

FIG. 2 is a cross sectional view of a representation of a hollow cathode discharge system;

FIG. 3 is a cross sectional view of an embodiment of a present invention apparatus for coating and/or treating an inner surface of a stent;

FIG. 4a is a cross sectional view of an arrangement for capacitively coupling RF power into a tube to produce a plasma;

FIG. 4b is a cross sectional view of an arrangement for inductively coupling RF power into a tube to produce a plasma;

FIG. 5 is a cross sectional view of an arrangement having a tube inserted within a microwave cavity so that microwave radiation may reach an interior of the tube;

FIG. 6 is a cross sectional view of an array of short tubes used to coat or treat a number of devices, e.g., stents, together;

FIG. 7 is a cross sectional view of a substrate having a discontinuous coating of atoms;

FIG. 8 is a cross sectional view of the substrate of FIG. 1 after etching; and,

FIG. 9 is a cross sectional view of a medical device manufactured according to an embodiment of present invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

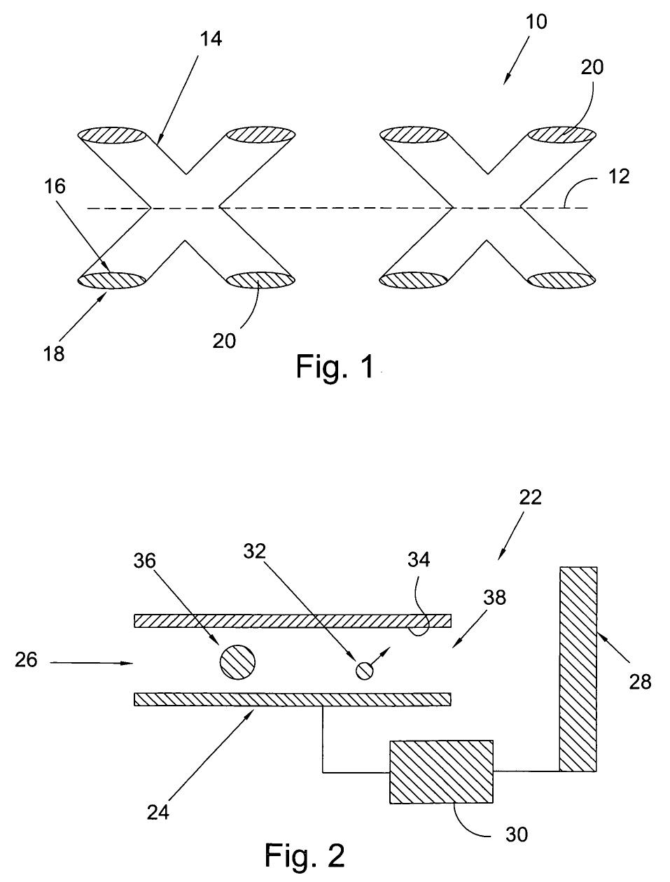

Adverting now to the figures, FIG. 1 shows a cross sectional view of a portion of a typical stent 10 taken generally along a plane parallel to longitudinal axis 12 of stent 10. Stent 10 is constructed from a plurality of struts 14, however for clarity, only two struts 14 are shown in FIG. 1. Struts 14 form a cage or scaffold, which holds open the lumen of a blood vessel and define a generally cylindrical envelope having longitudinal axis 12. Struts 14 have inner surfaces 16 and outer surfaces 18, while portions 20 represent the cut ends of struts 14. As discussed infra, the present invention method alters inner surfaces 16 through a coating or treatment without substantially altering outer surfaces 18 during the same processing. It should be appreciated that inner surface 16 of stent 10, i.e., the interior surfaces of the medical device, refers to the portion of the medical device which may be viewed from longitudinal axis 12. Therefore, outer surface 18 or exterior surfaces refer to the portion of the medical device which may not be viewed from longitudinal axis 12.

It is well known in the art of plasmas and plasma deposition that it is possible to produce a glow discharge inside of a tube, even a tube with a diameter of 1 millimeter (mm) or less, for example, using hollow cathode discharges. As one of ordinary skill in the art appreciates, hollow cathode discharges are primarily used as sources of electrons for a variety of applications such as ion beam neutralization, plasma enhancement and electron beam evaporation. FIG. 2 shows a representation of hollow cathode discharge system 22. Tube 24 has a source of gas 26 flowing through it and is held at a negative voltage with respect to a second electrode 28 by power supply 30. It should be appreciated that gas 26 may be an inert gas, e.g., argon, a reactive gas, e.g., oxygen, nitrogen, methane or mixtures thereof, or a precursor gas, e.g., hydrocarbon, metal containing gases, oxygen, nitrogen or mixtures thereof. In the embodiment shown in FIG. 2, tube 24 is a small tube. It should be appreciated that second electrode 28 could be a grounded surface which is part of a vacuum chamber, and need not be a discrete electrode as shown in FIG. 2. Alternatively, tube 24 could be the grounded surface and electrode 28 could be raised to a positive potential with respect to tube 24.

The general principal of operation of hollow cathode discharge system 22 is that electrons 32 emitted from inner surface 34 of tube 24 are confined by reflections at the opposite wall and effectively produce ions 36 in the gas flowing in tube 24 until electrons 32 exit end 38 of tube 24 and are collected by anode 28. Systems similar to hollow cathode discharge system 22 have been used to deposit material and plasma treat surfaces. See, e.g., U.S. Pat. No. 5,716,500 which describes the use of a hollow cathode discharge system as a source of coating material. Systems similar to hollow cathode discharge system 22 are usually operated at sub-atmospheric pressures, but it is also possible to operate some hollow cathode discharge systems at atmospheric pressures. See, e.g., “Characterization of Hybrid Atmospheric Plasma in Air and Nitrogen,” 49^{th} Annual Technical Conference Proceedings of the Society of Vacuum Coaters, 2006. Known methods of using hollow cathode discharge systems include placing a substrate to be coated or modified outside of the hollow cathode tube, e.g., tube 24. Contrarily, in the present invention, a substrate to be treated or coated lines the inside wall of the hollow cathode discharge system, i.e., inner surface 34 of tube 24, making the substrate an electrode in the plasma discharge system. Although the extremely small discharge volume in typical hollow cathode discharge systems limits their usefulness for etching or depositing on most substrates, their very size and shape make them ideal for etching or depositing on the inner surface of small objects having generally cylindrical shapes, such as stents, grafts and shunts.

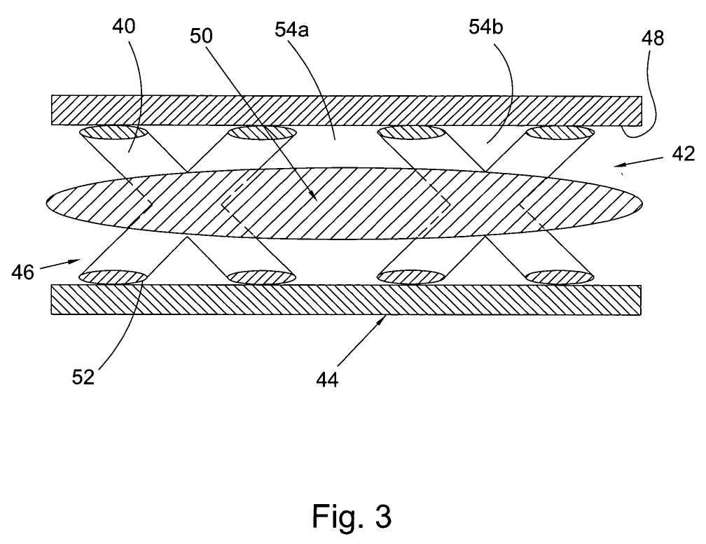

FIG. 3 shows a cross sectional view of an embodiment of a present invention apparatus for coating and/or treating inner surface 40 of stent 42. Stent 42 is inserted into tube 44 so that stent struts 46 (shown in cross-section as in FIG. 1) are in contact with inner surface 48 of tube 44. When hollow cathode discharge plasma 50 is created within tube 44, as described above, primarily inner surface 40 of struts 46 will be exposed to plasma 50 while outer surface 52 of struts 46, which are in contact with inner surface 48 of tube 44, will not receive as much exposure to plasma 50. In this way, inner surface 40 of stent 42 can be altered through a coating, a plasma etch treatment or a combination of both, while outer surface 52 of stent 42 is left almost unchanged, i.e., outer surface 52 is substantially shielded from exposure to plasma 50.

Various methods exist for using the present invention to treat or coat inner surface 40 of stent 42 or other medical devices having inner and outer surfaces. For example, a precursor gas such as methane or acetylene could be used alone or in combination with other gases such as argon to produce a carbon containing coating on inner surface 40. The formation of a coating by a plasma discharge in a precursor gas, or plasma enhanced chemical vapor deposition (PECVD) is well know in the art and many precursor gases, such as hexamethyldisiloxane, tetrafluoroethylene, and those containing metals such as titanium isopropoxide can be used.

Alternatively, the hollow discharge tube, e.g., tube 44 shown in FIG. 3 could be made of a material that is meant to be deposited on inner surface 40 of strut 46. For example, if tube 44 were made of titanium, because a significant portion of inner wall 48 of tube 44 is exposed through openings 54a and 54b in stent 42, i.e., the areas within and between struts 46, the bombardment of inner surface 48 of tube 44 by energetic ions, e.g., ions 36 shown in FIG. 2, will sputter titanium onto inner surface 40 of strut 46. Because plasma 50 will also bombard inner surface 40 of strut 46, not all of the titanium that is deposited will remain, however some will remain and mix with inner surface 40. Alternatively, by choosing a tube material that has a significantly different sputter yield than the stent material, it has been found that two or more materials may be effectively co-deposited to create an inhomogeneous surface on the inside surface of a stent without the use of lithography. It is believed that such a surface is conducive to endothelial cell growth. See, e.g., U.S. Pat. No. 6,820,676. It should be appreciated that, as used herein, sputter and sputtering is intended to mean removal of material by ion bombardment, and in some embodiments, includes the subsequent deposit of the removed material onto another surface, e.g., ion bombardment of an inner surface of a hollow electrically conducting tube removes material therefrom which is subsequently deposited on a medical device held within the hollow tube.

If it is desired to simply expose the inner surface of a device such as a stent to the energetic ion bombardment, for example to roughen the device or plasma activate the device for further processing, the hollow cathode discharge system tube can be made of a biocompatible, low sputter yield material, e.g., carbon. Because the device is biased at a negative voltage with respect to the anode, it will be impacted by ions that have been accelerated to high energy. Therefore, the surface of the device can be aggressively plasma etched, a coating can be put down with PECVD, or both can be done simultaneously.

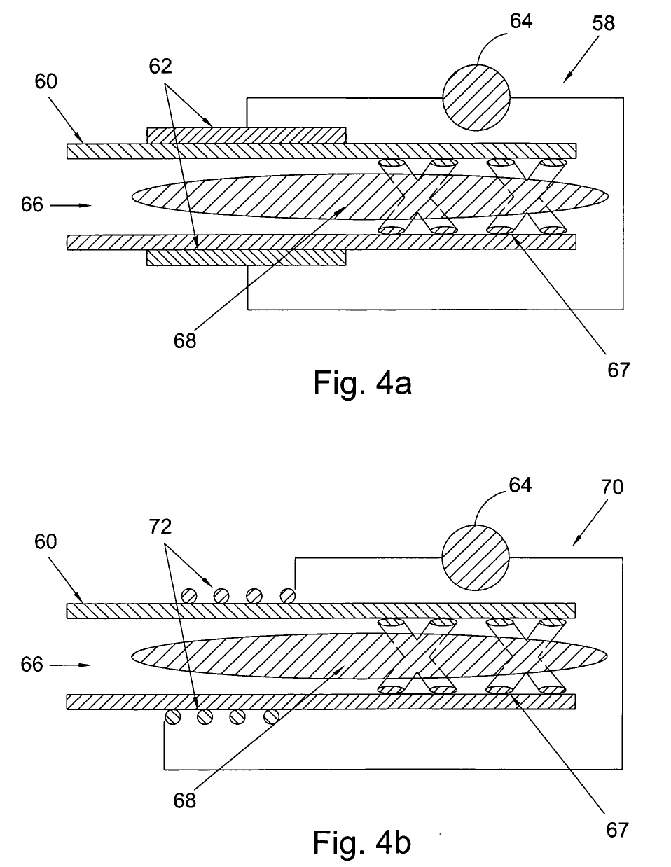

In addition to a hollow cathode discharge, it is possible to create a plasma on the inside surface of a medical device by other means. For example, an inductively or capacitively coupled radio frequency (RF) field can produce a glow discharge on the inside surface of an electrically insulating tube. The tube must have a low enough conductivity that the RF fields are not shielded from the interior portion. A gas, which can be inert or can contain a precursor for depositing a coating, can flow through the tube. In this case, because the stent or device may itself shield the interior of the tube from the RF fields, the treatment or deposition can take place remotely from where the power is coupled. FIG. 4a shows a cross sectional view of an arrangement for capacitively coupling RF power into a tube to produce a plasma and FIG. 4b shows a cross sectional view of an arrangement for inductively coupling RF power into a tube to produce a plasma. In FIG. 4a, plasma discharge device 58 comprises electrically insulating tube 60 and has separate electrodes 62 placed on opposite sides of tube 60 in a manner well known in the art. Radio frequency power supply 64 is connected to electrodes 62. Gas 66 is admitted into tube 60 and excited by power supply 64. Gas 66 may include any of the gases discussed supra, e.g., inert, reactive or precursor. The medical device, e.g., stent 67, is located remotely from the electrodes, as explained above, and is treated or coated in the flow of ionized and excited gas 68 downstream from the plasma generation portion, i.e., the area within tube 60 between electrodes 62, of plasma discharge device 58. FIG. 4b shows an alternative form a plasma discharge device, i.e., device 70, wherein electrodes 62 of device 58 are replaced by coil of wire 72. Coil 72 inductively couples power from power supply 64 into ionized and excited gas 68 in a manner well-known to those skilled in the art.

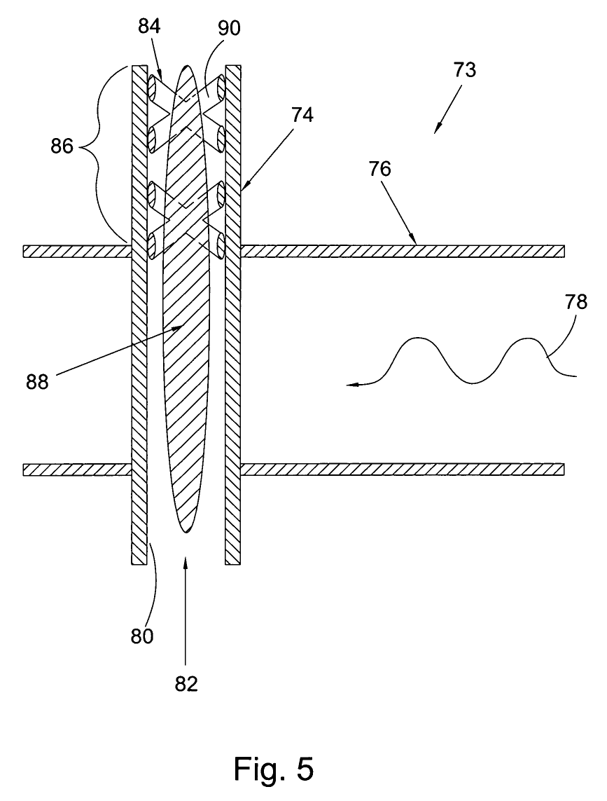

Alternatively, microwave power can be used to produce a discharge. In this instance, the tube that holds the medical device can be inserted into a microwave cavity, also known as a waveguide, in a manner well known to those of ordinary skill in the art. FIG. 5 shows a cross sectional view of an arrangement of discharge device 73 having tube 74 inserted within microwave cavity 76 so that microwave radiation 78 may reach interior 80 of tube 74. Gas 82, which may include any of the gases described supra, can flow through tube 74 and the medical device to be treated or coated, e.g., stent 84, can be placed in a portion of tube 74 outside of cavity 76, e.g., portion 86, where ionized gas 88 can reach interior surfaces 90 of medical device 84. It should be appreciated that medical device 84 is placed outside of cavity 76 so that its conductivity does not interfere with the propagation of microwaves 78. As discussed above, gas 82 can be an inert gas intended to modify the surface of medical device 84 through physical bombardment with ions, can be a reactive gas or can contain a precursor gas used to deposit a coating onto interior surface 90 of device 84.

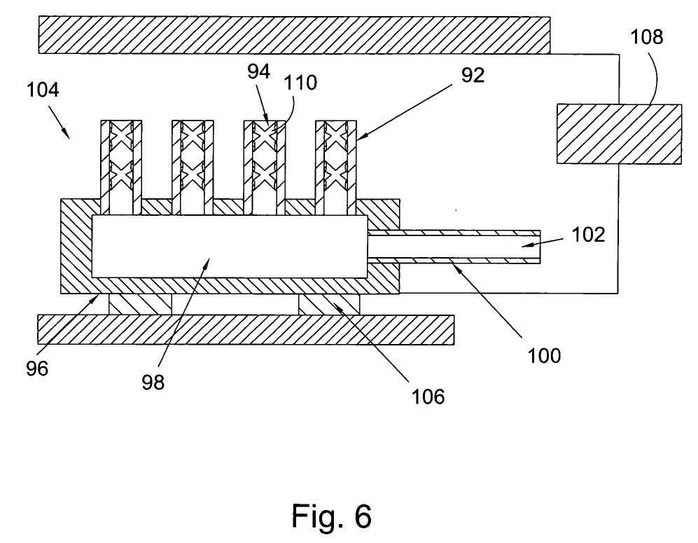

It should be appreciated that the present invention method may be used to produce large numbers of devices simultaneously. For example, a number of stents can line the inside of a long tube and be coated or treated at one time. Alternatively, an array of shorter tubes, as shown in the cross sectional view in FIG. 6, can be used to simultaneously coat or treat a number of devices. In the embodiment shown in FIG. 6, tubes 92, each of which holds one or more medical devices, e.g., stents 94, for treatment or coating, are arrayed in holder 96. Holder 96 includes hollow gas manifold 98 which is connected to tubes 92. Gas manifold 98 is fed by gas line 100 such that gas 102 flowing in line 100 is distributed substantially evenly to tubes 92. Assembly 104 is electrically insulated by means such as insulators 106 and is connected electrically to power supply 108. When power supply 108 applies a sufficient negative voltage to assembly 104, simultaneous hollow cathode discharges exist in tubes 92, which treat and/or coat inside surfaces 110 of medical devices 94 therein.

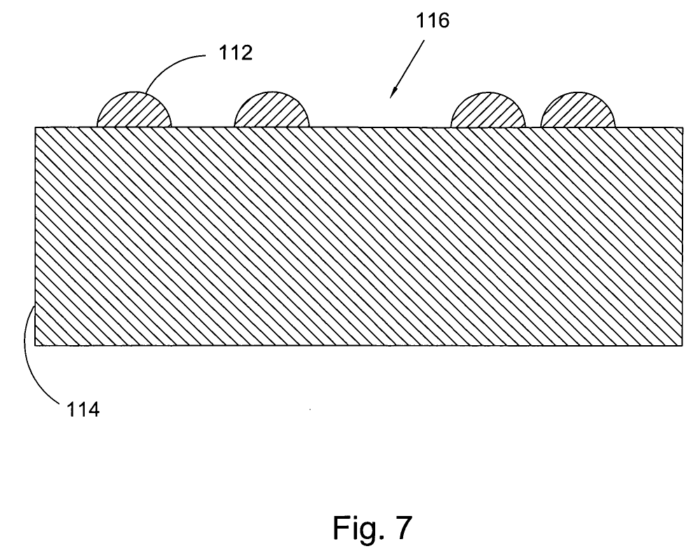

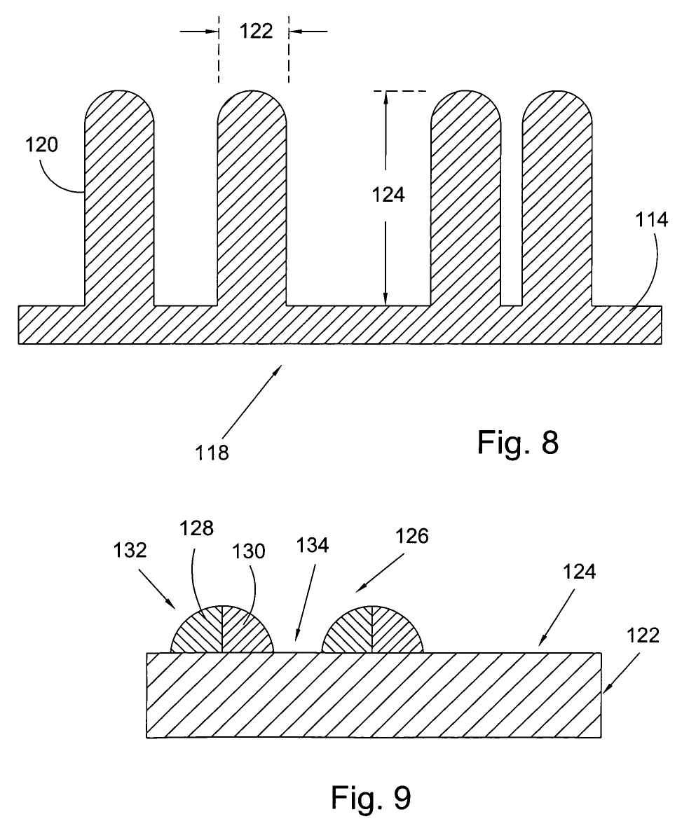

The inventive method of the present invention can be used in a variety of ways to alter the interior surfaces of medical devices. For example, it is possible to create an inhomogeneous surface by depositing a discontinuous coating of atoms of a first substance on a substrate comprising a second substance. In some embodiments, the substrate can then be etched via physical sputtering, while in other embodiments, the steps of depositing and etching are performed simultaneously. This deposition and etching sequence is described in U.S. Patent Application Nos. 60/771,834 and 11/704,650, which applications have been incorporated herein by reference and form the basis of priority for this application. In further embodiments, the discontinuous coating of atoms forms a plurality of clusters, each of the plurality of clusters having lateral dimensions from about ten nanometers to about one thousand nanometers. In yet further embodiments, the inhomogeneous surface includes a plurality of structures, each of the structures having heights from about ten nanometers to about ten thousand nanometers. The above described embodiments of the present invention are shown in FIGS. 7 and 8. FIG. 7 is a cross sectional view of a substrate having a discontinuous coating of atoms, more specifically, a coating of aluminum oxide (Al₂O₃) clusters 112 randomly spaced about titanium substrate 114 thereby forming coated substrate 116, while FIG. 8 is a cross sectional view of coated substrate 116 after etching. The following discussion is perhaps best understood in view of both FIGS. 7 and 8.

Ultra thin coatings deposited using physical vapor deposition, or in other words those layers having average thicknesses from less than a monolayer, i.e., a single atomic layer, to tens of monolayers, do not ordinarily condense as a uniform coating. Rather, the atoms nucleate as clusters whose size and spacing are determined by such factors as substrate temperature, chemical binding energy between the coating and substrate, energy of the arriving atoms, etc. Therefore, the average height of these clusters may be significantly greater than the average thickness of the overall coating, while the regions between the clusters are merely bare substrate material. The instant invention makes use of differences in etch rates that can exist between such clusters and the underlying substrate material, in order to produce structures that have dimensions of tens to hundreds of nanometers in breadth and height in and on the substrate.

In the embodiment shown in FIGS. 7 and 8, Ti substrate 114 is used as a base layer upon which Al₂O₃ clusters 112 are deposited. Al₂O₃ clusters 112 are attached to Ti substrate 114 and approximately several nanometers in height and approximately several nanometers in diameter. Under ion bombardment, the sputter yield of Al₂O₃ clusters 112, i.e., the number of Al₂O₃ atoms ejected from coated substrate 116 per incident ion, is approximately a few percent of that of the atoms ejected from Ti substrate 114. Thus, after depositing clusters 112 on Ti substrate 114, coated substrate 116 is subjected to ion bombardment to cause sputtering. Initially, coated substrate 116 will be etched only in those areas not covered by Al₂O₃ clusters 112. By continuing to etch coated substrate 116 until Al₂O₃ clusters 112 are removed, the resulting etched substrate 118 will have high aspect ratio structures 120 with spacings that reflect the original spacing of the Al₂O₃ clusters 112. Thus, FIG. 8 shows the results of coating Al₂O₃ clusters 112 on Ti substrate 114 to form coated substrate 116, and the subsequent removal of Al₂O₃ clusters 112 by ion bombardment. It has been found that even if the substrate material, e.g., Ti substrate 114, has a low sputter yield surface, such as a native oxide, removing that surface will require the same length of time in all locations. Therefore, the difference in sputter rates for the deposited clusters 112 and substrate 114 will still dictate the vertical size of the resulting structures 120. It should be noted that as used herein lateral dimension or diameter is used to refer to diameters 122, while vertical size, height and depth are used to refer to height 124.

Although coating a substrate with Al₂O₃ is described in the foregoing embodiment, one of ordinary skill in the art will recognize that a wide variety of coating materials may be used, e.g., metals, oxides, nitrides and alloys, and such variations are within the spirit and scope of the claimed invention. However, it has been found that metal oxides such as Al₂O₃ as well as oxides of Titanium (Ti), Molybdenum (Mo), Niobium (Nb), Chromium (Cr) and others have very low sputter yields and are, therefore, particularly advantageous when used for coating a substrate. Such materials are good candidates for producing randomly spaced clusters of atoms on a nanometer scale, such as Al₂O₃ clusters 112. Hereinafter, such nanometer scale coatings are referred to as a “nanomask.”

As those skilled in the art will appreciate, the nanomask, e.g., Al₂O₃ clusters 112 may be deposited using a source of the mask material or may be deposited reactively by, for example, sputtering a metal in a chamber containing oxygen (O₂), nitrogen (N₂), or some other compound forming gas. Any number of well-known means, such as sputtering, cathodic arc evaporation, thermal evaporation and chemical vapor deposition can deposit discontinuous clusters 112. As mentioned previously, the deposition conditions strongly affect clusters 112 size and spacing, and conditions are chosen which produce the desired results.

For the purposes of bone growth, nucleation characteristics resulting in a discontinuous coating of clusters 112 having diameters from about several nanometers to about several hundreds of nanometers, and heights from about several nanometers to about several hundreds of nanometers, have been found to be particularly advantageous. The dimensions of resulting structures 120 of course still depend on the ratio of the etch rate of substrate 114 to the etch rate of clusters 112. Although the aforementioned embodiment is described in terms of preferentially bonding to bone, one of ordinary skill in the art will recognize that a substrate have clusters of different dimensions than previously set forth will preferentially bond to other types of cells, and such variations are within the spirit and scope of the claimed invention. In a preferred embodiment, resulting structures 120 have lateral dimensions, i.e., diameters 122, from approximately ten (10) to several hundreds of nanometers across and heights 124 from approximately ten (10) to ten thousand (10,000) nanometers.

The height H of a given resulting structure 120 will be:

H=R×h,

Where h is the height of the initial cluster 112 that produced structure 120 and R is the ratio of the etch rate of substrate 114 to the etch rate of cluster 112. Of course, a given cluster 112 will not have a single height, but will be domed or otherwise irregular, and therefore, the resulting structure 120 may also be irregularly shaped. For example, as is well known from published sputter yields for Al₂O₃ and Ti, an Al₂O₃ nanomask deposited on a Ti substrate and sputtered using 500 electron volts (eV) under Argon (Ar) will result in a ratio R of approximately 17. Therefore, if a nanomask cluster of atoms had a height h of 10 nanometers, the height H of the resulting structure would be approximately 170 nanometers.

In order to control the nucleation characteristics of the nanomask coating, it is possible to change the chemical binding energy between substrate 114 and the coating material, e.g., Al₂O₃. For example, a very thin layer of a material having weak chemical bonding with the nanomask material, such as a hydrocarbon, may be deposited onto the substrate prior to the deposition of the coating material. Such a low energy coating, as it is known, will result in fewer, larger nuclei of the nanomask material, clusters 112. Alternatively, it is possible to use plasma cleaning as an integral part of the coating process to change the nucleation characteristics. In that case, an initial high voltage can be applied to substrate 114 in order to clean substrate 114 and remove any residual contamination. This cleaning may be done with the deposition source off or it may be carried out during the initial stages of deposition. Times for such cleaning may range from less than a minute to several minutes.

For purposes of cell attachment, coated substrate 116 may not require etching in order to form preferred sites for cell growth. In certain cases, it is possible that material boundaries formed between substrate 114 and clusters 112 will produce enough of discontinuity in surface characteristics to stimulate the attachment of cells at the locations of clusters 112 and/or therebetween clusters 112. It has been found, for example, that material boundaries on such scales may result in relatively large local electric fields, which may enhance the attachment of biological materials at those locations. For example, a discontinuous coating of Gold (Au) on Ti may result in large chemical potentials at the boundaries of the two materials that stimulate biological materials, such as proteins, to locate preferentially at those boundaries. As one of ordinary skill in the art will appreciate, other types of dissimilar materials are also candidates for such nanoscale coating clusters, and such variations are within the scope of the claimed invention.

Clusters 112 may be deposited on otherwise smooth portions of substrate 114 or it is also possible to form clusters 112 on the surfaces of a sintered powder, thereby creating a surface with two roughness scales. In addition, if clusters 112 are porous they may be infused with bioactive materials, such as superoxide dismutuse to inhibit inflammation or proteins to promote bone growth.

As described supra, once clusters 112 are deposited on substrate 114, thereby forming coated substrate 116, structures 118 can be produced by etching coated substrate 116. Any etching known in the art may be used, such as reactive or non-reactive ion etching. For example, introducing an inert gas such as Argon at a pressure from approximately one (1) mTorr to one hundred (100) Torr, and applying a voltage to coated substrate 116 that is high enough to cause physical sputtering, typically between one hundred (100) and one thousand (1000) volts (V), will result in the desired etching. The sputtering voltage may be direct current (DC), pulsed DC, radio frequencies (RF) in the megahertz range, or an intermediate frequency, i.e., alternating current (AC), and such voltage should be applied under conditions that produce a glow discharge. The gas used may be inert, such as Ar, or can be chosen to accentuate the difference in sputtering rates between clusters 112 and substrate 114. For example, if clusters 112 are a metal oxide and substrate 114 is a polymer, it is known in the art that a plasma containing O₂ will etch the polymer very quickly while etching the metal oxide slowly. Such a process is known as reactive ion etching and relies on chemical processes as well as physical bombardment to remove material.

The above described etching processes are common in the electronics industry, where etch masks are routinely used to produce specific desired patterns in integrated circuits, for example. However, in those cases the patterns that define the final structure are made using lithography, which is an expensive process. In the method of the instant invention, the patterns are formed on the surfaces of implantable devices by choosing deposition conditions that form a random pattern of clusters of atoms, and therefore is far more cost effective and simple to perform than lithography processes.

The deposition of clusters 112 and subsequent etching of coated substrate 116 may be done in one continuous operation, or may be performed sequentially. An example of a continuous operation is depositing Al₂O₃ clusters 112 onto Ti substrate 114 using RF sputtering. During deposition of clusters 112, a voltage may also be applied to substrate 114. The voltage should be kept low enough that it will not cause clusters 112 to be removed faster than they are deposited. However, once clusters 112 are properly deposited on substrate 114, the voltage may be increased to cause sputtering of both clusters 112 and substrate 114 in such a way that there is a net removal of material, and the formation of nanostructures 120 as described above. It has been found that using RF sputtering to deposit clusters 112 is a relatively inefficient deposition process. That is, a relatively intense RF plasma is needed to produce even a small deposition rate of a nanomask material such as Al₂O₃. However, because the nanomask material is so thin on average, a low deposition rate is often acceptable. The advantage of using RF sputtering arises once the nanomask is deposited. By leaving the RF power on and applying a DC voltage to coated substrate 116, the intense RF plasma provides a dense source of ions which are available to etch coated substrate 116. In other words, applying a DC voltage to coated substrate 116 in the presence of RF plasma will produce a far greater etch rate than applying the same voltage in the absence of RF plasma. Even though there are still sputtered atoms arriving at coated substrate 116, they are removed as quickly as they arrived by the combined effect of the dense plasma and high substrate voltage.

Alternatively, the deposition and etching steps may be sequential. If both steps are accomplished using sputtering, this may be accomplished by simply turning off the power to the deposition source of clusters 112 and turning on the power to substrate 114. Or alternatively, the deposition and etching steps may take place in separate chambers.

It should be appreciated the above described sputtering of the hollow tube and medical device contained therein may occur simultaneously, and an example of such is shown in FIG. 9. FIG. 9 shows a cross sectional view of medical device 122 manufactured according to an embodiment of present invention. Simultaneously sputtering both the hollow tube and medical device 122 modifies interior surface 124 of medical device 122 to comprise inhomogeneous surface 126, wherein inhomogeneous surface 126 comprises at least two materials, e.g., first and second materials 128 and 130, respectively. Inhomogeneous surface 126 includes a plurality of individual regions 132, and each of these regions 132 comprises at least two materials, e.g., first and second materials 128 and 130, respectively. Individual regions 132 are separated from other individual regions by material boundary 134.

Furthermore, the present invention method allows for the creation of different surfaces on the inside and outside of medical devices, e.g., stents, which serve different purposes. For example, it may be possible to first deposit a material only on the outside of the medical device that enhances the biocompatibility of that surface with respect to a lumen wall. This could be done using conventional deposition techniques such as sputtering, evaporation, spray coating, plasma polymerization or others while using a mandrel to prevent coating on the interior surface of the device. In a separate operation, the present invention method could be used to create another surface on the inside of the medical device that serves an alternative purpose, for example, biocompatibility with blood rather than tissue or promotion of endothelial cell growth via a rough surface or inhomogeneous surface.

In some instances, it may be useful to use a drug that prevents cell growth for a period of time in combination with a medical device whose inner surface has been altered so that it promotes endothelial cell growth. In these instances, the textured inner surface may cause platelet attachment, which is undesirable, during the period of time when the drug is preventing cell growth. It has been found that this issue can be addressed by coating at least the inner surface of the medical device with a biodegradable polymer. The smooth surface of the polymer suppresses platelet attachment while the drug acts to prevent cell growth. When the polymer is gone, i.e., has degraded, and the drug no longer acts to prevent cell growth, the surface of the medical device that promotes endothelial cell growth is then exposed and becomes effective.

A further advantage of the present invention relates to controlling the temperature of medical devices during their coating or treatment. For example, if the inside diameter of the hollow cathode or discharge tube is slightly smaller than the outside diameter of the device, the device will remain in intimate contact with the tube during processing. Therefore, if the tube is cooled, for example by a circulating liquid, the medical device can also be cooled during processing. This is particularly important for medical devices made of a nickel/titanium alloy known as Nitinol. Nitinol has the unusual properties of superelasticity and shape memory which result from the fact that Nitinol exists in a martensitic phase below a first transition temperature, known as M_{f}, and an austenitic phase above a second transition temperature, known as A_{f}. Both M_{f} and A_{f} can be manipulated by altering the ratio of nickel to titanium in the alloy as well as changing the thermal processing of the material. In the martensitic phase, Nitinol is very ductile and easily deformed, while in the austenitic phase Nitinol has a high elastic modulus. Applying stresses to materials at temperatures above A_{f} produces some martensitic materials, however when the stresses are removed, the material returns to its original shape. This results in a very springy behavior for Nitinol, referred to as superelasticity or pseudoelasticity. Furthermore, if the temperature is lowered below M_{f} and the Nitinol is deformed, raising the temperature above A_{f} will cause the Nitinol to recover its original shape. This property is described as shape memory.

It is well known that if Nitinol is raised to too high a temperature for too long of a period of time, the A_{f} value will rise. Additionally, sustained temperatures above 300-400 degrees Centigrade will adversely affect typical A_{f} values used in medical devices. Likewise, if stainless steel is raised to too high a temperature, it can lose its temper, while other materials would also be adversely affected by exposure to such conditions. Therefore, the time-temperature history of a medical device during a coating operation is critical. In view of the foregoing, the present invention allows the temperature of a device to be controlled directly while uniformly treating or coating its interior surface.

It should also be appreciated that the present invention method can also be used to selectively remove material from the interior surfaces of medical devices. For example, many polymer deposition processes used to coat devices are conformal, i.e., a process of spraying a dielectric material onto a device to protect it from moisture, fungus, dust, corrosion, abrasion, and other environmental stresses. Parylene, which is widely used as a coating material, is deposited by polymerizing a monomer vapor, and thereby coating parylene on all exposed surfaces. As has been discussed above, it may be desirable to remove such a polymer coating from the interior surface while leaving it on the exterior surface. Thus, the present method can be used to plasma etch a polymer using an oxygen containing plasma, thereby removing it from the interior surface while leaving it on the exterior surface as desired.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A method of manufacturing a medical device comprising interior and exterior surfaces, said method comprising the steps of:
a) shielding said exterior surface; and,
b) exposing said interior surface to a plasma, wherein said shielding of said exterior surface substantially prevents exposure of said exterior surface to said plasma.

2. The method of claim 1 wherein said medical device further comprises a first cross-sectional shape; said step of shielding said exterior surface further comprises the step of: contacting said exterior surface of said medical device with an inner surface of a hollow electrically conducting tube, said inner surface having a second cross-sectional shape substantially similar to said first cross-sectional shape; and, said step of exposing said interior surface to said plasma further comprises the step of: igniting a hollow cathode discharge within said hollow electrically conducting tube.

3. The method of claim 2 wherein said step of exposing said interior surface to said plasma further comprises the step of: simultaneously sputtering said tube and said medical device.

4. The method of claim 3 wherein said step of simultaneously sputtering said tube and said medical device modifies said interior surface of said medical device to comprise an inhomogeneous surface comprising at least two materials.

5. The method of claim 4 wherein said inhomogeneous surface comprises a plurality of individual regions and each of said individual regions comprises at least two materials and is separated from others of said individual regions by a material boundary.

6. The method of claim 2 wherein said step of exposing said interior surface to said plasma further comprises the step of: cooling said hollow electrically conducting tube.

7. The method of claim 1 wherein said medical device further comprises a first cross-sectional shape; said step of shielding said exterior surface further comprises the step of: contacting said exterior surface of said medical device with an inner surface of a hollow electrically insulating tube, said inner surface having a second cross-sectional shape substantially similar to said first cross-sectional shape; and, said step of exposing said interior surface to said plasma further comprises the step of: igniting a discharge within said hollow electrically insulating tube using a radio frequency power.

8. The method of claim 7 wherein said radio frequency power comprises a capacitively coupled radio frequency field.

9. The method of claim 7 wherein said radio frequency power comprises an inductively coupled radio frequency field.

10. The method of claim 7 wherein said step of exposing said interior surface to said plasma further comprises the step of: cooling said hollow electrically insulating tube.

11. The method of claim 1 wherein said medical device further comprises a first cross-sectional shape; said step of shielding said exterior surface further comprises the step of: contacting said exterior surface of said medical device with an inner surface of a hollow electrically insulating tube, said inner surface having a second cross-sectional shape substantially similar to said first cross-sectional shape; and, said step of exposing said interior surface to said plasma further comprises the step of: igniting a discharge within said hollow electrically insulating tube using a microwave power.

12. The method of claim 11 wherein said step of exposing said interior surface to said plasma further comprises the step of: cooling said hollow electrically insulating tube.

13. The method of claim 1 wherein said step of exposing said interior surface to said plasma is performed in an inert gas.

14. The method of claim 1 wherein said step of exposing said interior surface to said plasma is performed in a reactive gas selected from the group consisting of: oxygen, nitrogen, methane and mixtures thereof.

15. The method of claim 1 wherein said step of exposing said interior surface to said plasma is performed in a precursor gas, and said precursor gas is selected to deposit a coating on said interior surface.

16. The method of claim 15 wherein said precursor gas is selected from the group consisting of: a hydrocarbon, a metal containing compound, oxygen, nitrogen and mixtures thereof.

17. The method of claim 15 wherein said coating comprises a plurality of clusters, each of said clusters comprises a lateral dimension from about ten nanometers to about one thousand nanometers.

18. The method of claim 16 wherein each of said clusters comprises a size and a distance from others of said clusters.

19. The method of claim 18 wherein said size of each of said clusters and said distance from others of said clusters are chosen to preferentially bind at least one biological structure having a specific size.

20. The method of claim 1 wherein said step of exposing said interior surface to said plasma removes material from said interior surface of said medical device.

21. The method of claim 1 further comprising the step of:
c) coating at least said interior surface of said medical device with a biodegradable polymer after said step of exposing said interior surface to said plasma.

22. A medical device constructed according to the method of claim 1.

23. A medical device having an interior surface, an exterior surface and means for exposing said interior surface to at least one plasma.

24. The medical device of claim 23 wherein said at least one plasma comprises a first plasma and a second plasma, said first plasma deposits a plurality of clusters on said interior surface and said second plasma etches said interior surface.

25. The medical device of claim 24 wherein said first and second plasmas produce a plurality of surface structures on said medical device.

26. The medical device of claim 25 wherein each of said surface structures comprises a lateral dimension from about ten nanometers to about one thousand nanometers.

27. The medical device of claim 25 wherein each of said surface structures comprises a height from about one hundred nanometers to about ten thousand nanometers.

28. The medical device of claim 24 wherein each of said clusters comprises a size and a distance from others of said clusters.

29. The medical device of claim 28 wherein said size of each of said clusters and said distance from others of said clusters are chosen to preferentially bind at least one biological structure having a specific size.
